(19) United States
(12) Patent Application Publication
(10) Pub. No.: US 2002/0143841 A1
(43) Pub. Date: Oct. 3, 2002

(54) Multiplexer based parallel n-bit adder circuit for high speed processing

(75) Inventors: Aamir A. Farooqui, Sunnyvale, CA (US); Vojin G. Oklobdzija, Berkeley, CA (US); Farzad Chehrazi, San Jose, CA (US)

Correspondence Address: WAGNER, MURABITO & HAO LLP, Third Floor, Two North Market Street, San Jose, CA, 95113, US

(73) Assignee: SONY CORPORATION AND SONY ELECTRONICS, INC.

(21) Appl. No.: 09/933,623

(22) Filed: Aug. 20, 2001

Related U.S. Application Data
(63) Continuation of application No. 09/275,068, filed on Mar. 23, 1999.

(51) Int. Cl. G06F 7/50

(52) U.S. Cl. 708/710; 708/714

(57) ABSTRACT

A multiplexer based adder circuit. The novel adder design is suitable for a number of bit sizes, but in one exemplary embodiment is a 64-bit adder. A complete 16-bit scaled adder is taught. The adder circuit is efficient and reconfigurable in that the adder can be partitioned to support a variety of data formats. The adder can add two 64-bit operands, four 32-bit operands, eight 16-bit operands, or sixteen 8-bit operands. The reconfigurability of the adder for different word sizes is achieved using only a small number of control signals for partitioning without increasing the adder size or reducing its speed. The novel adder circuit is designed using multiplexer circuits and two input inverted logic gates making the adder very fast. The adder design recognizes that pass transistor based multiplexer circuits and inverted logic gates are the fastest circuit elements for standard CMOS logic. In particular, the generate and propagate circuits of the carry tree each include a multiplexer and an inverted two input logic gate. The first level of the carry tree logic groups operand bits by groups of four thereby significantly reducing the logic required to generate the appropriate carry signals. The adder circuit is also optimized for hardware by having a hardware efficient circuit for performing selective addition. The adder can be used for multi-media applications and is also well suited for very long instruction word (VLIW) processors. The critical timing path of the adder includes 7 multiplexers and 1 XNOR gate, e.g., log(n)+1, where n is the number of bits of the adder.

### BACKGROUND OF THE INVENTION

1. Field of the Invention

The present invention relates to the field of circuitry used for implementing arithmetic operations. More specifically, the present invention relates to adder circuits for adding two n-bit operands.

2. Related Art

The adder circuit is one of the most commonly used digital circuits for general purpose computing and signal processing. Fast parallel binary addition is essential to modern digital computers. As such, much effort has been devoted to maximizing the adder's performance, and many different schemes and architectures have been proposed. In the ripple carry adder, the carry signals from one bit sum circuit are fed, e.g., rippled, to the next higher bit sum circuit. However, in a ripple carry adder, for an n-bit adder, there can be as many as n logic levels required to perform the addition since each sum circuit needs to wait for its carry-in signal from its downstream sum circuit. In modern computer technologies, system clock speeds are great and the data word sizes are large. This is especially true for multi-media and other audio/video processors and hardware units. Within such processors, it is often required to provide 64-bit adders within their arithmetic logic units (ALUs). Therefore, a ripple carry adder is much too slow for practical use within such a large n-bit adder.

Conditional sum adders are an important class of adder design. Conditional sum adders reduce the computation time by precomputing the sum for all possible carry bit values (e.g., “0” and “1”), and after the carry becomes available, the correct sum is selected using a multiplexer. However, conditional sum adders suffer from fan-out limitations since the number of multiplexers that need to be driven by the carry signal increases exponentially. A modification of conditional sum adders have also be developed and used. These adders are called conditional carry adders since the conditional sum adder principle applies to only the carry generation circuit. However, in this configuration, all carry bits are derived as a function of the carry input and the carry input is expected to drive n multiplexers. In high-speed adder designs, fan-out limitations may seriously degrade the estimated speed of addition. Another addition scheme utilizes carry select addition. However, conventional carry select addition requires a large number of transistors because separate adder circuits are required for carry=1 and also for carry=0.

It is well known that the delay time of a standard ripple-carry adder can be dramatically decreased by employing the scheme of the carry lookahead addition that makes the slow signals arrive earlier. For decades, carry lookahead adders have been the popular choice of fast parallel adders. Carry lookahead adders result from expanding the recurrence equation that describes the set of carries generated by the adder circuitry. In effect, the carry lookahead adder speeds up the addition operation by “unrolling” the recursive carry equation. In an article entitled, “A Regular Layout for Parallel Adders,” published in the IEEE Transactions on Computers, Vol. C-31, No. 3 (March 1982), Richard P. Brent and H. T. Kung described a binary carry lookahead parallel adder.

FIG. 1 illustrates a carry tree 50 used in a Brent and Kung style adder that is described in an article entitled, “A 3.5 ns, 64 bit, carry-lookahead adder,” published in 1996 IEEE International Symposium on Circuits and Systems, p. 297-300 vol. 2, by D. Dozza, M. Gaddoni and G. Baccarani. Within the carry tree 50, the “g” signals refer to carry generate signals and the “p” signals refer to carry propagate signals. Carry generation operations are performed at the operators 10 (first logic level) and the operators 20 at the last logic level generate the carry signals C1 through C5 for a 16-bit adder. However, in this design, 2(log₂(n)−1) logic levels are required, since both a direct and an inverse binary trees are needed to generate all the output carry bits. The Brent and Kung adder design requires a relatively large amount of transistor area and interconnects to implement its binary carry tree 50 of FIG. 1.

Both transistor count and interconnection complexity limit the application of the Brent and Kung adder design. Therefore, while the Brent and Kung adder produces highly regular structure with high speed, it has not been widespread because of the additional delay and area penalty introduced by the exponentially growing interconnection complexity. With ever shrinking VLSI process geometries, wire delay and power considerations are as important in many designs as the design's transistor count and chip area. Although shrinking geometries allow transistors to become smaller, their interconnect wiring still poses several electrical problems. As the wiring is placed closer and closer together, parasitic capacitance becomes a larger problem and introduces unwanted impedances into the signal propagations. This obviously introduces unwanted delays into the adder design. Therefore, it would be advantageous to reduce the transistor count and wiring of an adder thereby reducing the number of interconnects required. This would provide more substrate area between interconnects to reduce unwanted capacitance.

Moreover, within the adder design, shortening the critical path is the most common way to reduce the propagation delay. Therefore, it would be advantageous to provide an adder design that contained a short critical path within the carry generation logic. Also, in may adder circuits partitioning is performed by controlling the carry-in signal to each partitioned portion of the adder by adding gating logic in the carry chain. An adder partitioning technique used in the AltiVec™ technology is described by Martin S. Schmookler et al. in a paper entitled “A Low Power, High-speed Implementation of a PowerPC™ Microprocessor Vector Extension,” pages 1-8, available from IBM Corporation, 11400 Burnet Rd, Austin, Tex. 78758, presented at the IEEE Arith. 14 Conference, Australia. However, this is not a good approach in high speed applications because the carry chain is along the critical timing path of the adder. Moreover, increasing the adder size in proportion to the partition increases the delay of the adder. It would be advantageous to provide a partitioning architecture that does not impact the overall critical path of the adder circuit.

### SUMMARY OF THE INVENTION

Accordingly, the present invention provides a multiplexer based carry lookahead adder circuit design that has a significantly reduced transistor count compared to other carry lookahead adder designs. Further, the present invention provides a carry lookahead adder that has an improved carry delay within the critical timing path. The adder design of the present invention also provides a hardware optimized carry select addition circuit. The present invention also provides a highly configurable adder circuit capable of being partitioned to support varying word lengths and data formats without adding gating logic and delay to each carry-in signal of each partitioned portion along the carry chain.

A multiplexer based adder circuit is described herein. The adder design of the present invention is suitable for a number of bit sizes, but in one exemplary embodiment is a 64-bit adder. A complete 16-bit scaled adder is taught. The adder circuit is efficient and re-configurable in that the adder can be partitioned to support a variety of data formats. The adder can add two 64-bit operands, four 32-bit operands, eight 16-bit operands, or sixteen 8-bit operands. The reconfigurability of the adder for different word sizes is achieved using only a small number of control signals for partitioning without increasing the adder size or reducing its speed.

The adder circuit of the present invention is designed using multiplexer circuits and two input inverted logic gates making the adder very fast. The adder design recognizes that pass transistor based multiplexer circuits and inverted logic gates are the fastest circuit elements for standard CMOS logic. In particular, the generate and propagate circuits of the carry tree each include a multiplexer and an inverted two input logic gate thereby increasing the propagation speed of the carry signals. The first level of the carry tree logic groups operand bits by groups of four, rather than by groups of two, thereby significantly reducing the logic required to generate the appropriate carry signals. This also makes the carry delay of the adder proportional to Olog(n), where n is the number of bits of the adder.

In the summation circuitry, one embodiment of the adder circuit of the present invention is also optimized for hardware by having a hardware efficient circuit for performing addition using a carry select method. The carry select adder operates in parallel with the carry tree. Each summation circuit includes two 4-bit adder functions, one for computing the sum with a carry in equal to 1 and another function for computing the sum with a carry in equal to 0. The two functions are combined into a single, hardware efficient, circuit. The adder can be used for multi-media applications and is also well suited for very long instruction word (VLIW) processors. The critical timing path of the 64-bit adder includes 7 multiplexers and 1 XNOR gate, e.g., log(n)+1, where n is the number of bits of the adder.

More specifically, an embodiment of the present invention includes an n-bit adder circuit having: a carry tree circuit for generating propagate and generate signals, the carry tree circuit comprising (logn) logic levels wherein a first logic level comprises (n/4) 4-bit generate and propagate (GP) circuits which each receive 4 bits of an n-bit operand A and also receive 4-bits of an n-bit operand B and wherein a first 4-bit GP circuit of the first logic level produces generate signal g03 and also produces propagate signal p03; and also having a sum circuit coupled to respective n-bits of the A and B operands and for generating an n-bit sum based thereon, the sum circuit comprising (n/4) 4-bit carry select adders that receive a portion of the generate signals wherein a first 4-bit carry select adder receives a carry-in and generating bits 0-3 of the sum and wherein a second 4-bit carry select adder receives the g03 signal and generates bits 4-7 of the sum.

### BRIEF DESCRIPTION OF THE DRAWINGS

FIG. 1 illustrates a carry tree that represents the carry generation logic of the prior art for a 16-bit adder circuit.

FIG. 2 is a truth table illustrating the generation of the generate and propagate signals used by the present invention.

FIG. 3 illustrates a carry tree that represents the 4-bit groups within the carry generation logic used by the adder circuit of the present invention.

FIG. 4 illustrates a diagram portion of a 4-bit group generate and propagate logic portion of the carry tree diagram of FIG. 3 used in accordance with the present invention.

FIG. 5 is a circuit diagram of the gates used in accordance with one embodiment of the present invention to implement the 4-bit group generate and propagate logic portion of FIG. 4.

FIG. 6 is a circuit diagram of an adder implemented in accordance with the present invention including both the carry tree logic and the sum logic circuits.

FIG. 7A and FIG. 7B illustrate a circuit schematic of the carry tree logic used in accordance with an embodiment of the present invention for a 16-bit adder and illustrate the critical path of the carry delay.

FIG. 8 is a circuit schematic of the merged carry select adder used in accordance with an embodiment of the present invention.

### DETAILED DESCRIPTION OF THE INVENTION

In the following detailed description of the present invention, a parallel multiplexer based carry lookahead adder having reduced transistor count and a fast critical timing carry path, numerous specific details are set forth in order to provide a thorough understanding of the present invention. However, it will be recognized by one skilled in the art that the present invention may be practiced without these specific details or with equivalents thereof. In other instances, well known methods, procedures, components, and circuits have not been described in detail as not to unnecessarily obscure aspects of the present invention.

### Notation and Nomenclature

Table I below illustrates notation and nomenclature that are used herein in describing the adder circuit of the present invention.

TABLE I

| Symbol | Meaning |
|---|---|
| n | number of bits of the input operand |
| ai | a operand’s ith bit |
| bi | b operand’s ith bit |
| k | level of the adder from 0 to (logn −1) |
| * | bitwise AND operation |
| + | bitwise OR operation |
| gi | generate signal at bit position “i” |
| pi | propagate signal at bit position “i” |
| gij | group generate of “i” to “j” bits |
| pij | group propagate of “i” to “j” bits |
| gi,j | gij |
| pi,j | pij |
| Ci | carry signal generated at bit position “I” |
| @ | bitwise XOR operation |

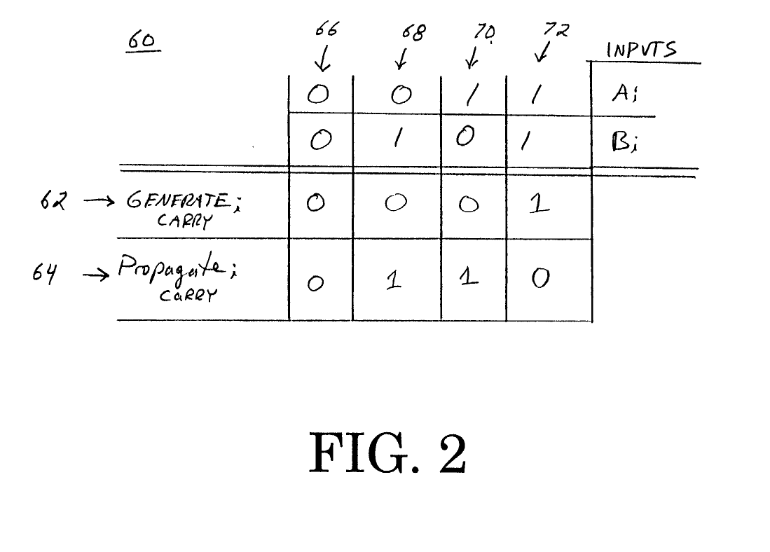

FIG. 2 illustrates a table 60 that represents the generate signal 62 and the propagate signal 64 for the ith bits (Ai and Bi) of two operands A and B. The generate signal 62 indicates when the sum logic for the ith bit position generates a carry signal. The generate signal 62 is asserted when both bits are “1” (column 72) because this condition generates a carry signal regardless of the carry in from the downstream logic (e.g., from the I-1 bit position). When both bits are “0,” (column 66) the generate signal 62 is not asserted because the carry will be “0” regardless of the carry in from the downstream logic. The propagate signal 64 indicates when the sum logic for the ith bit position propagates the carry signal from the downstream logic, regardless of its value. Therefore, the propagate signal 64 is “1” when the ith bits are “0” and “1” (column 68) or “1” and “0” (column 70). In this case, if the carry-in is “1,” then the carry-out will be “1” and if the carry-in is “0” then the carry-out will be “0.” At column 72, the generate signal 62 takes priority.

### Carry Generation Tree Circuit

As seen from FIG. 2, the generate, gi, and propagate, pi, signals can be computed from the below equations:

gi=ai*bi (1)

pi=ai@bi

where “@” is a bitwise XOR function. The carry out, Ci, from the ith bit position is represented by:

Ci=gi+(pi*C(i−1)) (2)

provided C0 is zero. The “o” operator is defined by Brent and Kung, and is given as follows:

(g, p)o(g′, p′)=(g+(p*g′),p*pi) (3)

Based on (1) above, the group generate and propagate signals are given by:

(g0i, p0i)=(g0, p0) if i=0; and (gi, pi)o(g0i−1, p0i−1) if 0<i<n (4)

where g0i is a group generate from bit zero to bit i and p0i is a similar group propagate. Using (3), the generate and propagate signals for each level of the adder circuit are generated using the following combinations:

(g0i+2^{k}, p0i+2^{k})=(gi+2^{k}, pi+2^{k})o(g0i, p0i)ₖ for 0<k<logn (5)

where g0i+2^{k} is a group generate and p0i+2^{k} is a group propagate. Using (5), the number of generate (Gₖ) and propagate (Pₖ) signals at each kth level of the adder circuit are given by:

Gₖ=n−2^{k} (6)

Pₖ=n−2^{k} (7)

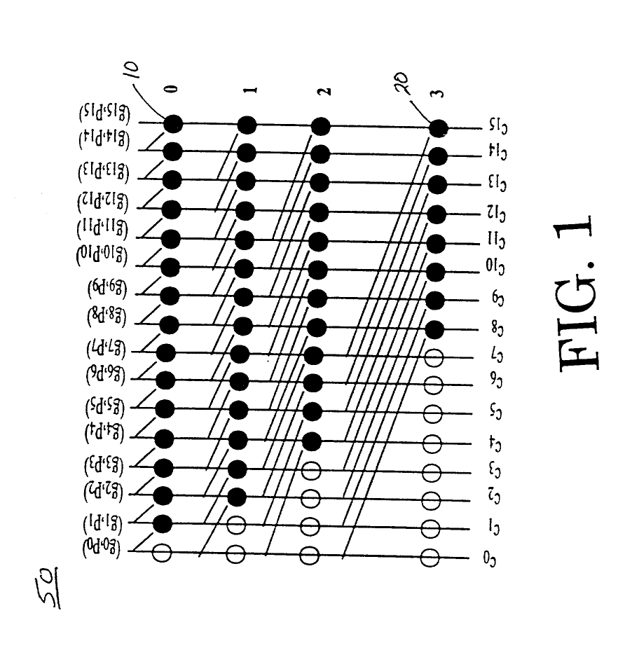

In Brent and Kung's adder design, the structure for an n bit adder includes a direct and inverse tree used for generating the n carries which results in 2(logn−1) levels. In the Dozza and Gaddoni adder design, the number of levels is reduced to log n by embedding the inverse tree within the direct one as shown in the tree 50 of FIG. 1. Since an ‘o’ operator takes four inputs and produces two outputs, the number of wires (Wₖ) and carry generate logic (CLₖ) at each kth level of the adder are given by:

Wₖ=2(n−2^{k}) (8)

CLₖ=2(n−2^{k}) (9)

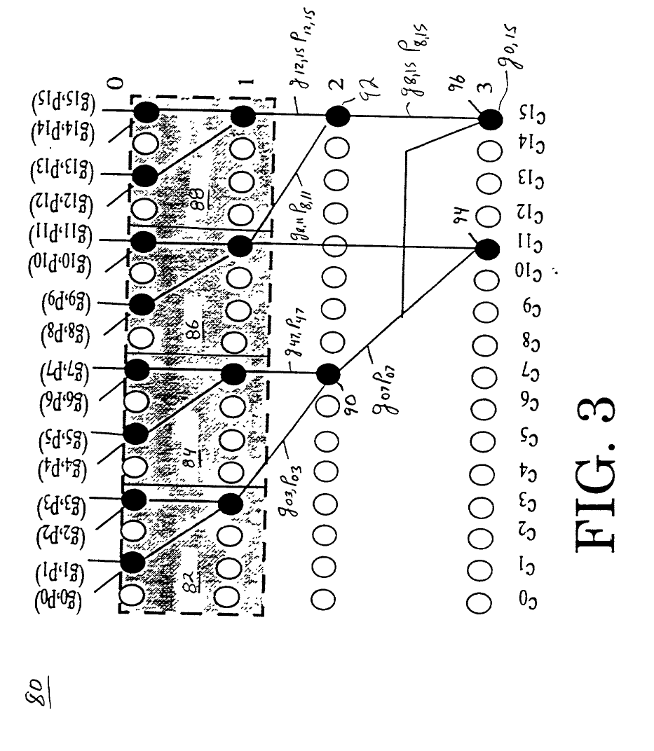

In contrast, FIG. 3 illustrates the carry tree structure 80 used by the n-bit adder circuit of the present invention for an exemplary 16-bit adder (n=16). This structure 80 can readily be expanded to support a 64-bit adder (n=64) which is also an embodiment of the present invention. At level “0,” of the carry tree structure 80 in accordance with the present invention only n/2 generate and propagate signals are produced using the following combination:

(g02i+1, p02i+1)=(g2i+1, p2i+1)o(g02i, p02i) for o<i<n/2

where g02i+1 is a group generate and p02i+1 is a group propagate and g02i, p02i, g2i+1 and p2i+1 are the generate and propagate signals at bit position 2i and 2i+1, respectively.

With reference to FIG. 3, at level “1” of the carry tree structure 80 of the present invention, n/4 propagate and generate signals are produced (by grouping the carries generated at the “0” level) using the same combination but limiting i to n/4. Block 82 represents the 4-bit group and receives g0 through g3 and p0 through p3 and generates g03, p03. Block 84 represents the next 4-bit group and receives g4 through g7 and p4 through p7 and generates g47 (e.g., the group generate signal representing bits 4 through 7) and p47 (e.g., the group propagate signal representing bits 4 through 7). Block 86 receives g8 through g1 and p8 through p11 and generates g8,11 and p8,11. Lastly, for the 16-bit case, block 88 is the last 4-bit block and receives g12 through g15 and p12 through p15 and generates g12,15 and p12,15. The above signals are the four bit group generate and propagate signals, their value for the 4-bit case (block 82) is given below.

(g01, p01)=(g1, p1) o (g0, p01)

(g23, p23)=(g3, p3) o (g2, p2)

(g03, p03)=(g23, p23) o (g01, p01)

It is appreciated that in accordance with the present invention, no g02 or p02 signals or intermediate even carry is generated because these are generated within by the conditional sum adders. This realization significantly reduces the transistors required of the carry structure 80 of the present invention. Once the 4-bit group carries are provided, the carries in multiples of 4 are generated using the same recursion as (2) above.

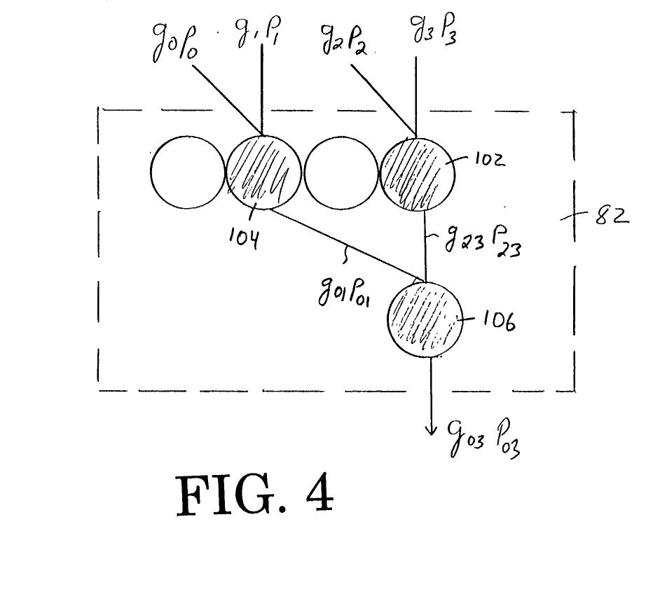

FIG. 4 illustrates the groupings of the 4-bit case of block 82. Circuit block 82 is a 4-bit generate and propagate circuit. Signals g0, p0 are fed to circuit 104 which generates g01, p01. Signals g2, p2 are fed to circuit 102 which generates g23, p23. Signals g01, p01 and signals g23 and p23 are fed to circuit 106 which generates g03, p03.

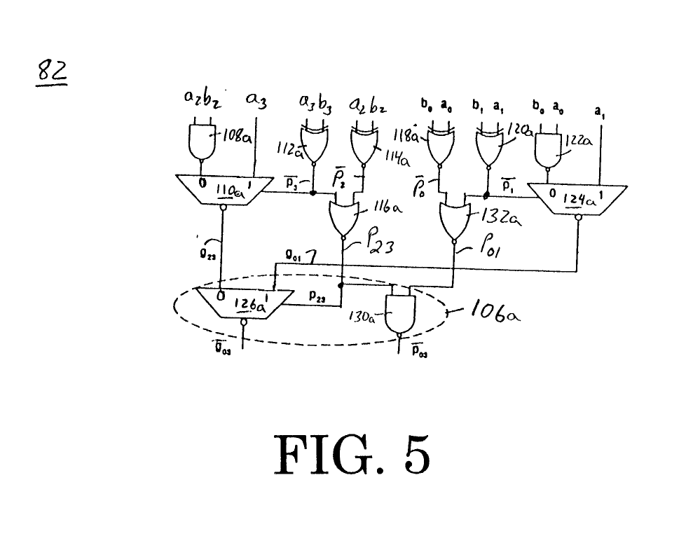

FIG. 5 illustrates the 4-bit generate and propagate (GP) circuitry 82 used to implement the 4-bit case of block 82 (FIG. 4) in one embodiment of the present invention. In accordance with the present invention, by using 4-bit groupings, only two signals, namely #g03 and #p03, are generated from level “0” and level “1” of the carry tree structure. Within the circuit of FIG. 5, g01=bit a1, if (a1 XNOR b1)=0 and g01=a0*b0, if (a1 XNOR b1)=1 taking advantage of the property that g1=1 and p1=1 can never occur. Once the two bit generate and propagate signals are computed, the 4-bit (and higher) group generate and propagate signals are computed using one level of a two-to-one mux and NAND/NOR gate respectively. It is appreciated that AND-OR-Invert (AOI) cells could have been used alternatively, however, the delay of AOI cells is higher than the delay of the mux circuit. In addition, AOI requires a buffer to drive more than two gates. The present invention provides a hybrid of the carry select and binary carry lookahead adder. Therefore, the final sum is calculated based on the generated carry signals.

In FIG. 5, the bits from the input operands, A and B are shown. The circuitry 82 shown in FIG. 5 can be used to implement any block of blocks 82-88 by merely altering the input operand bits. In each case, four bits from operand A and four bits from operand B are received. Circuit 82 contains inverting gate circuitry and inverting multiplexers for increased speed. Bits a0 and b0 are fed to NAND gate 122a which feeds an input of inverting multiplexer (“mux”) 124a. The other input of mux 124a receives bit a1. Bits a1 and b1 are fed to XNOR gate 120a whose output, #p1 (“not p1,” also called “p1 bar”), controls the select line of mux 124a and feeds an input of NOR gate 132a. Bits a0 and b0 are fed to XNOR gate 118a whose output, #p0, is fed to the other input of NOR gate 132a. The output of NOR gate 132a is fed to an input of NAND gate 130a. The output of inverting mux 124a is fed to an input of inverting mux 126a. The output of XNOR gate 118a generates #p0. The output of XNOR gate 120a generates #p1.

Bits a2 and b2 of FIG. 5 are fed to NAND gate 108a which feeds an input of inverting mux 110a. The other input of mux 110a receives bit a3. Bits a3 and b3 are fed to XNOR gate 112a whose output controls the select line of mux 110a and feeds an input of NOR gate 116a. Bits a2 and b2 are fed to XNOR gate 114a whose output is fed to the other input of NOR gate 116a. The output of NOR gate 116a is fed to the other input of NAND gate 130a. The output of inverting mux 110a is fed to the other input of inverting mux 126a. The output of NAND gate 112a generates #p3. The output of NAND gate 114a generates #p2.

The output of NOR gate 116a also controls the select line to inverting mux 126a. The output mux 126a generates #g03. The output of NAND gate 130a generates #p03.

Referring back to FIG. 3, circuit 90 and circuit 92 are within level “2” of the carry tree structure 80 of the present invention. Circuit 90 receives signals g03 and p03 and signals g47 and p47. Circuit 90 generates signals g07 and p07. Circuit 92 receives signals g8,11 and p8,11 and signals g12,15 and p12,15. Circuit 92 generates signals g8,15 and p8,15. Circuit 94 and circuit 96 are within level “3” of the carry tree structure 80 of the present invention. Circuit 94 receives signals g07 and p07 and signals g8,11 and p8,11. Circuit 94 generates signal g0,11 also called C11. Circuit 96 receives signals g07 and p07 and signals g8,15 and p8,15. Circuit 96 generates signal g0,15 also called C15 which is the carry out signal for a 16-bit adder (n=16).

It is appreciated that, with respect to FIG. 3, for n bits, n/2^{k} (for k=0 to 1, e.g., at level 1 and level 2) signals are generated for the first two levels of the adder circuit of the present invention and n/2 signals are generated for the remainder of the levels of the adder circuit. The final carry of n-bits (e.g., C15 in FIG. 3) is generated in log n number of steps. The number of wires for each level are reduced from 2(n−2^{k}) to approximately (n/2). Moreover, the number of circuit blocks are also reduced from (nlog n) to:

$$\frac{( 2 n + log n - 2 ) n }{8}$$

for the entire adder circuit. This value is arrived by [n/2+n/4+(logn−2) n/8+3n/4+n/2] including circuit blocks and multiplexers where 2 multiplexers equal one circuit block required in the conditional sum adders. Table II below illustrates the number of circuit blocks required in accordance with the present invention for each tree level with respect to a 64 bit adder.

TABLE II

| Adder level | # of Circuit Blocks | # of Wires |
|---|---|---|
| 0 | 32(n/2) + 48(3n/4) | 64n |
| 1 | 16(n/4) | 32(n/2) |
| 2 | 8(n/8) | 24(<n/2) |
| 3 | 8(n/8) | 24(<n/2) |
| 4 | 8(n/8) | 24(<n/2) |
| 5 | 8(n/8) | 24(<n/2) |
| | 32(n/2, mux. logic) | |
| Total | 160 | 192 |

For a 64-bit adder circuit (n=64), the carry tree structure 80 of the present invention requires only 50 percent of the circuit blocks required of the Brent and Kung adder and requires only 30 percent of the number of wires required of the Brent and Kung adder.

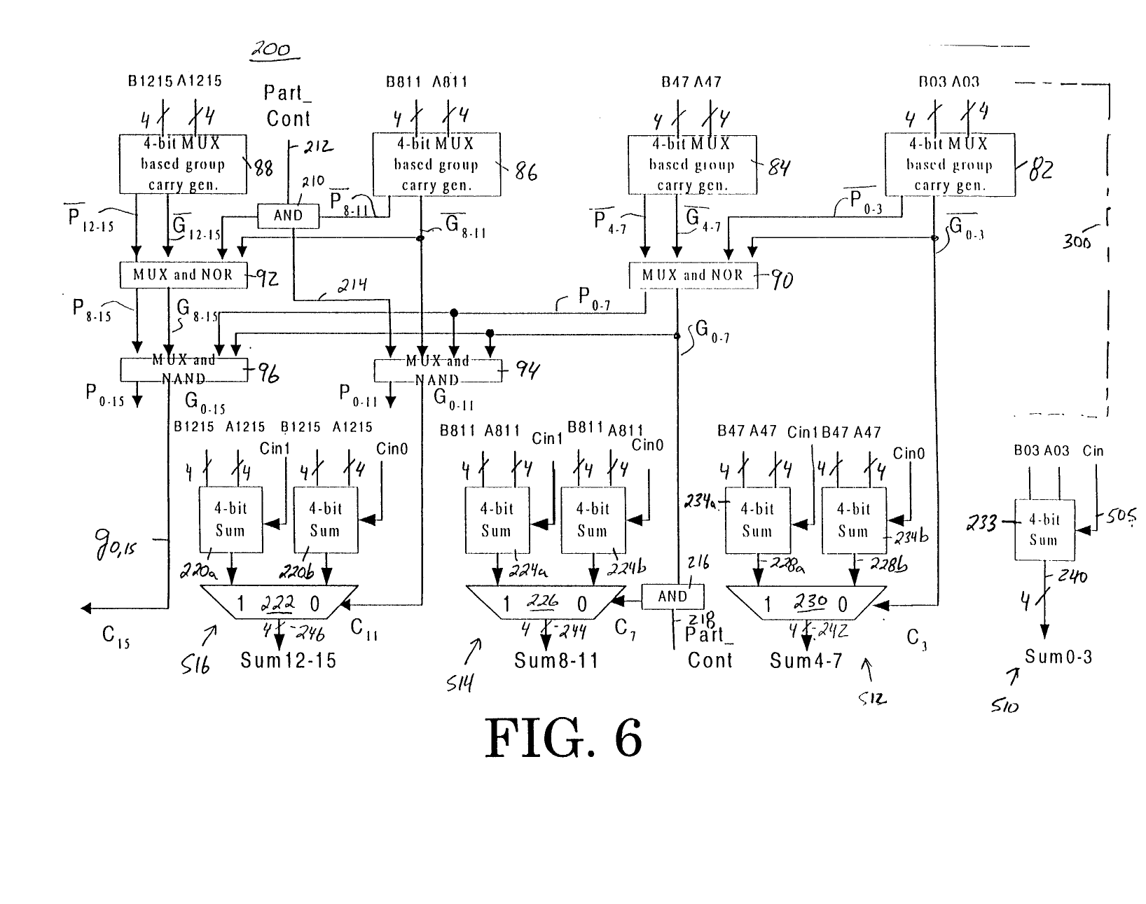

FIG. 6 illustrates one embodiment of the n-bit adder circuit 200 in accordance with the present invention for a 16-bit adder (n=16). It is appreciated that this design can readily be expanded to incorporate larger sized adders, such as 32-bit adders and 64-bit adders. With respect to the 64-bit adder of the present invention (n=64), circuit 200 represents only the first 16-bit portion and is replicated four times (with appropriate alterations of the input bits) to arrive at the entire 64-bit adder. In one embodiment of the adder, in order to obtain the highest speed using static CMOS standard cells and fulfill requirements for long word length (e.g., for use in multi-media applications), the adder of the present invention as been restricted to NAND, NOR, XNOR and two-to-one multiplexers. In this embodiment, the multiplexers are realized using transmission gates and inverters which offer the delay comparable to a single gate. In another embodiment, fan in/out is limited to only 2/4, respectively, and for higher fan out, buffers are used. The adder design is highly modular for VLSI implementation and multi-media applications, as examples.

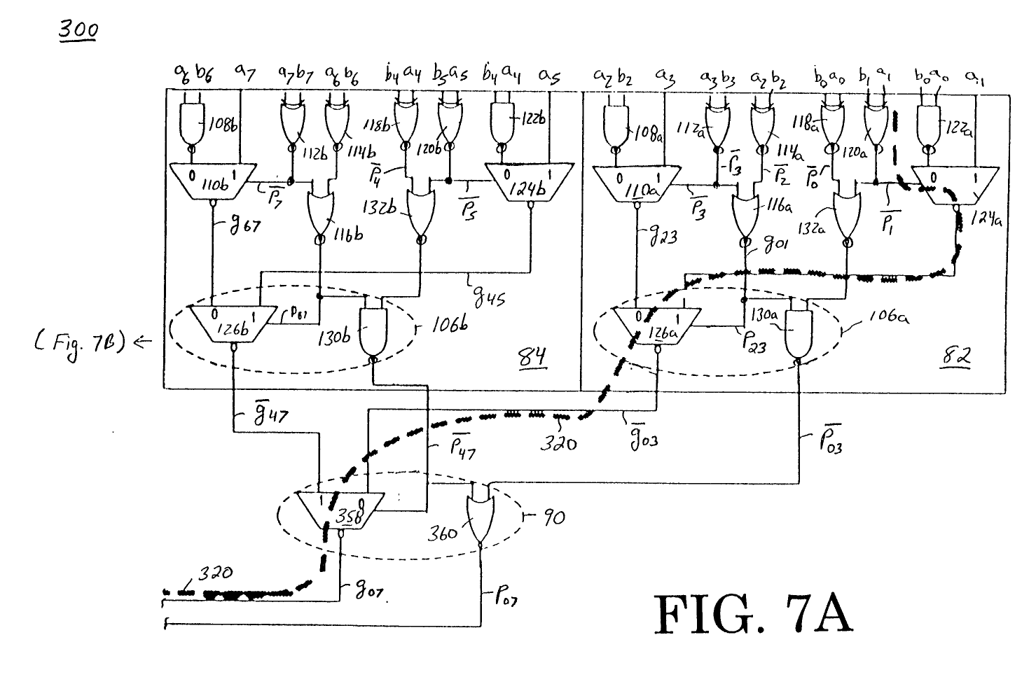

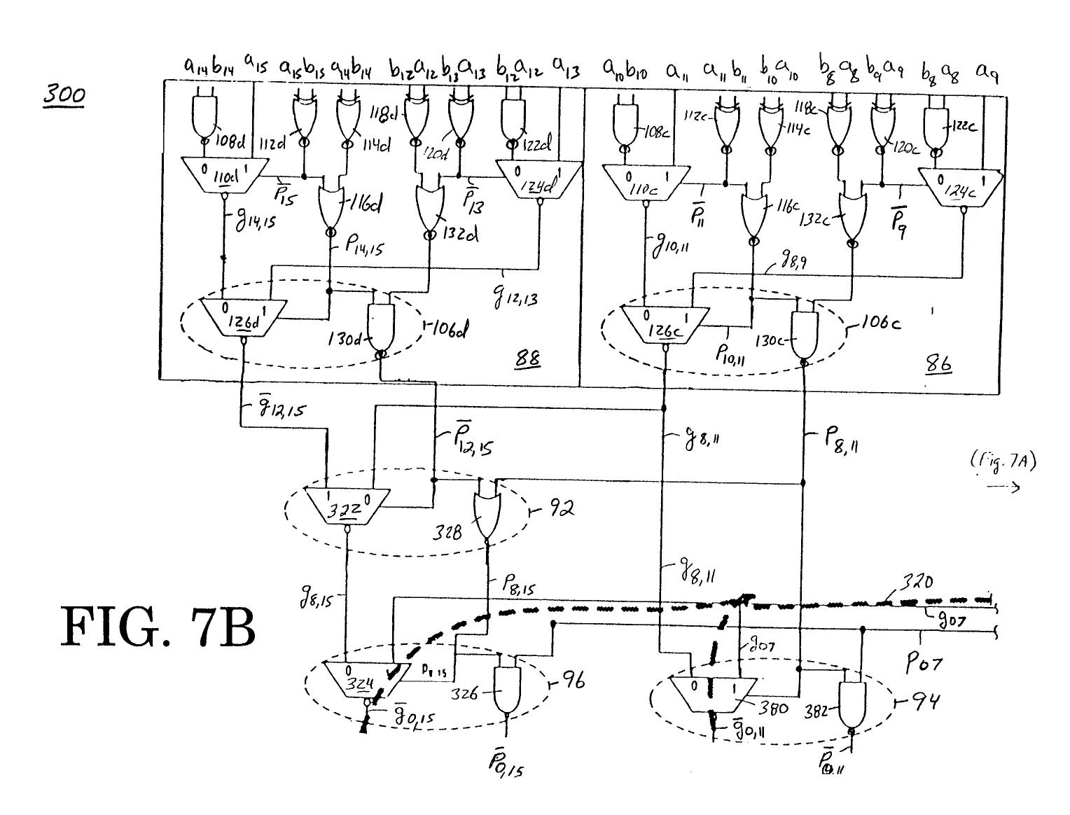

As shown in FIG. 6 adder circuit 200 includes a particular circuit embodiment 300 of the carry tree structure 80 of the present invention. In adder circuit 200, bits a0-a3 and bits b0-b3 of operands A and B, respectively, are coupled to circuit block 82 (described in FIG. 5). Circuit 82 is a 4-bit carry generate and carry propagate circuit and generates signals #p03 and #g03 (also the C3 signal). Bits a4-a7 and bits b4-b7 of operands A and B, respectively, are coupled to carry generate and carry propagate circuit block 84. Circuit 84 is analogous to circuit 82 (FIG. 5) with bits 4-7 replacing bits 0-3, respectively for each operand. A circuit implementation of circuit 84 is shown in FIG. 7A. Circuit 84 of FIG. 6 generates signals #p47 and #g47. Bits a8-a11 and bits b8-b11 of operands A and B, respectively, are coupled to carry generate and carry propagate circuit block 86. Circuit 86 is analogous to circuit 82 (FIG. 5) with bits 8-11 replacing bits 0-3, respectively, for each operand. A circuit implementation of circuit 86 is shown in FIG. 7B. Circuit 86 generates signals #p8,11 and #g8,11. Bits a12-a15 and bits b12-b15 of operands A and B, respectively, are coupled to carry generate and carry propagate circuit block 88. Circuit 88 is analogous to circuit 82 (FIG. 5) with bits 12-15 replacing bits 0-3, respectively, for each operand. A circuit implementation of circuit 88 is shown in FIG. 7B. Circuit 88 generates signals #p12,15 and #g12,15.

Level “2” carry generation and propagation circuit 90 of FIG. 6 receives group propagate signals #p03 and #p47 and also receives group generate signals #g03 and #p47. Circuit 90 generates group propagate signal p07 and group generate signal g07. A circuit implementation of circuit 90 is illustrated in FIG. 7A and includes an inverting multiplexer 358 and a NOR gate 360.

Level “2” carry generation and propagation circuit 92 of FIG. 6 receives group propagate signal #p12,15 and also receives group generate signals #g12,15 and #g8,11. Group propagate signal #p8,11 is ANDed with a partition control signal from line 212 at AND gate 210 and the result is supplied to circuit 92. Circuit 92 generates group propagate signal p8,15 and group generate signal g8,15. A circuit implementation- of circuit 92 is illustrated in FIG. 7B and includes an inverting multiplexer 322 and a NOR gate 328. As described more fully below, the partition control signal of line 212 is used for partitioning the adder circuit 200 for performing addition on operands of variable data lengths. By applying the partition control signal to the propagate and carry signals via AND gates 210 and 216, the present invention is able to implement partitioning without adding to the delay of the adder circuit 200.

Level “3” carry generation and propagation circuit 94 of FIG. 6 receives group propagate signals p07 and the ANDed version of #p8,11 supplied over line 214 from AND gate 210. Circuit 94 also receives group generate signals g07 and #g8,11. Group propagate signal #p8,11 is ANDed with a partition control signal from line 212 at AND gate 210 and the result is supplied to circuit 94. Circuit 94 generates group propagate signal p0,11 and group generate signal g0,11 which is also the C11 signal. A circuit implementation of circuit 94 is illustrated in FIG. 7B and includes an inverting multiplexer 380 and a NAND gate 382.

Level “3” carry generation and propagation circuit 96 of FIG. 6 receives group propagate signals p07 and p8,15. Circuit 96 also receives group generate signals g07 and g8,15. Circuit 96 generates group propagate signal p0,15 and group generate signal g0,15 which is also the C15 signal. The C15 signal is the carry out for this 16-bit adder stage shown in FIG. 6. A circuit implementation of circuit 96 is illustrated in FIG. 7B and includes an inverting multiplexer 324 and a NAND gate 326.

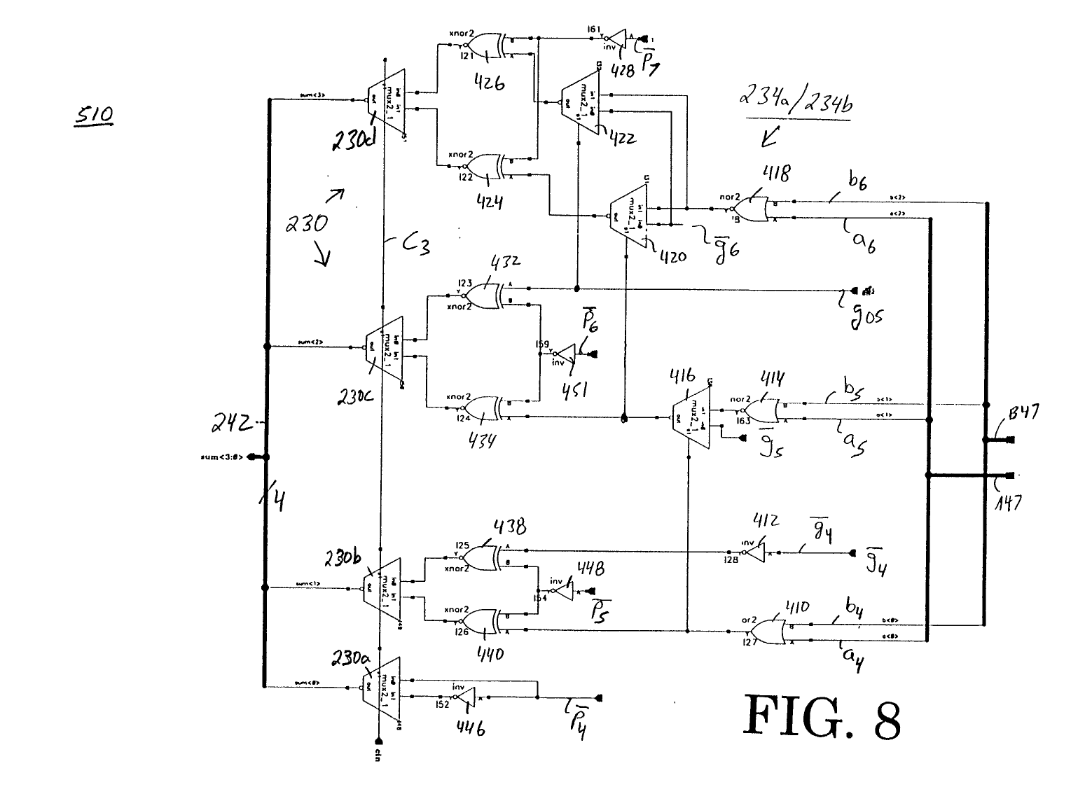

As described below, generate signals that are computed in the carry tree circuit 300 are used by sum circuits to arrive at the correct resultant sum value in accordance with the present invention. Therefore, the carry select adders 512-516 (and 4-bit sum adder 233) operate in parallel with the recursive carry generation circuit 300 and the carry select adders generate two sums cased on Cin=0 and Cin=1 for 4-bit groups. When the actual carry value becomes available for the group via the fast carry generation circuit 300, the correct sum is selected by carry select adder multiplexers. Carry signals C11, C7 and C3 are forwarded from the carry generation circuit 300 to the carry select adder circuits 512-516. The carry in, Cin 505, is optional and is supplied to 4-bit adder 510. Although not shown, in one embodiment, the intermediate single bit propagate signals, #p0 through #p15 (as well as the single bit generate signals) are coupled from their associated 4-bit circuit blocks 82-88 to their respective carry select adder circuits 510-516. They are used by the carry select adder, in this embodiment, in the fashion shown in FIG. 8.

The adder circuit 200 of FIG. 6 contains three carry select adder circuits 512-516 that each generate a four bit sum based on a carry select addition technique. Assuming circuit 200 was the second stage of a multi-bit adder, then four carry select adders would be used. With respect to the first 4-bit sum, 240, produced by sum circuit 233, it is produced assuming that cin=0 on line 505, therefore there is no need of extra logic for calculating the sum of Cin=1. Sum circuit 510 therefore contains one 4-bit adder 233 which receives bits 0-3 of the A and B operands. Because this 4-bit adder 233 is not within the critical timing path of the adder circuit 200 of the present invention, any type of a number of well known adder circuits can be employed as circuit 233. The 4-bit adder 233 is based on a carry-in signal of “0.” The output of 4-bit adder circuit 233 is supplied over 4-bit bus 240 and represents bits 0-3 of the resultant sum of operands A and B.

Carry select sum circuit 512 contains two 4-bit adders 234a and 234b which each receive bits 4-7 of the A and B operands. The 4-bit adder 234a is based on a carry-in signal of “1” while the 4-bit adder 234b is based on a carry-in signal of “0.” The output of 4-bit adder circuit 234a and the output of 4-bit adder circuit 234b are simultaneously supplied to a multiplexer 230. Because this 4-bit adders 234a and 234b are not within the critical timing path of the adder circuit 200 of the present invention, any type of a number of well known adder circuits can be employed. The generate signal #g03, also called C3, that was generated from the carry tree circuit 300 is used to control the select line of the multiplexer 230 so that the correct sum value is selected. The four bit result is supplied over 4-bit bus 242 and represents bits 4-7 of the resultant sum of operands A and B.

Sum circuit 514 contains two 4-bit adders 224a and 224b which each receive bits 8-11 of the A and B operands. The 4-bit adder 224a is based on a carry-in signal of “1” while the 4-bit adder 224b is based on a carry-in signal of “0.” The output of 4-bit adder circuit 224a and the output of 4-bit adder circuit 224b are simultaneously supplied to a multiplexer 226. The generate signal g07 (from carry circuit 300) is fed to AND gate 216 which generates an output signal modified by the partition control signal of line 212. The output of AND gate 216 controls the select line, as C7, of multiplexer 226 so that the correct sum value is selected. The four bit result is supplied over 4-bit bus 244 and represents bits 8-11 of the resultant sum of operands A and B.

The remaining sum circuit 516 contains two 4-bit adders 220a and 220b which each receive bits 12-15 of the A and B operands. The 4-bit adder 220a is based on a carry-in signal of “1” while the 4-bit adder 220b is based on a carry-in signal of “0.” The output of 4-bit adder circuit 220a and the output of 4-bit adder circuit 220b are simultaneously supplied to a multiplexer 222. The generate signal g0,11, also called C11, that was generated from the carry tree circuit 300 of the present invention is used to control the select line of the multiplexer 222 so that the correct sum value is selected. The four bit result is supplied over 4-bit bus 246 and represents bits 12-15 of the resultant sum of operands A and B.

FIG. 7A and FIG. 7B illustrate a circuit implementation of the carry tree circuit 300 of FIG. 6. Also shown is the critical timing path 320 representing the longest delay in computing the last carry signal, C15. As shown, the four bit group carry (propagate) signal is generated in 1-XOR and 2 multiplexer (NOR) delays. The critical path 320, shown as a broken line, of the adder circuit 200 is very predictable starting from a1, b1 (FIG. 7A) and going onto C35, . . . , C63 for a 64-bit adder. In the example 16-bit circuit, the critical path terminates in FIG. 7B with the generation of signal g0,15. The number of gates in this carry path (for 64-bits) is equivalent to 6 multiplexers (log 64) and 1-XOR delay. The correct sum, for 64-bits, is produced in 7-multiplexer delays including the delay of the carry select adder multiplexer. In the 16-bit example, the correct sum is produced in 5-multiplexer delays (including the carry select adder multiplexer).

Because the four bit carry select adders 510-516 are not on the critical timing path 320, they can be implemented using two sets of four ripple carry adder circuits, with Cin=0 for one set and Cin=1 for the other set. In one embodiment, the present invention includes a design, as shown in FIG. 8, that merges the two adders and thereby reduces the amount of hardware required to implement the two 4-bit adder functions. This embodiment reduces the required hardware by approximately 40 percent.

FIG. 8 illustrates a hardware optimized embodiment of the carry select adder circuit 512 in accordance with the present invention. Circuit 512 is shown as an example, and the other carry select circuits can be implemented in an analogous fashion. In this embodiment, the functionality of two 4-bit adders are combined into a single adder circuit thereby reducing the hardware required to implement circuits 234a and 234b. In effect, a combination circuit 234a/234b is realized in lieu of using separate circuits to perform the carry select addition. In FIG. 8, the multiplexer 230 is shown in detail as four multiplexers 230a-230d which receive the same select control signal (C3).

The LSB multiplexer 230a receives the signal #p4 at one input and receives an inverted signal p4 at the other input from inverter 446. The output of multiplexer 230a is bit 0 of the resultant sum and carried over bit 0 of 4-bit bus 242. Multiplexer 230b, at one input receives the output of XNOR circuit 440 which receives the output of OR circuit 410 and also receives the output of inverter circuit 448. Inverter circuit 448 receives the #p5 signal. Multiplexer 230b, at the other input receives the output of XNOR circuit 438 which receives the output of-inverter circuit 412 and also receives the output of inverter circuit 448. Inverter circuit 412 receives the #g4 signal. OR gate 410 receives bits 4 of the A and B operand. The output of multiplexer 230b is bit 1 of the resultant sum and carried over bit 1 of 4-bit bus 242.

Multiplexer 230c of FIG. 8, at one input receives the output of XNOR circuit 434 which receives the output of multiplexer circuit 416 and also receives the output of inverter circuit 451. Inverter circuit 451 receives the #p6 signal. Multiplexer 230c, at the other input receives the output of XNOR circuit 432 which receives the output of inverter circuit 451 and also receives the signal g05. Multiplexer circuit 416 receives at one input the #g5 signal and at the other input and output of NOR gate 414 which receives bits 5 of the A and B operand. The select line of multiplexer 416 is controlled by the output of gate 410. The output of multiplexer 230c is bit 2 of the resultant sum and carried over bit 2 of 4-bit bus 242.

Multiplexer 230d of FIG. 8, at one input receives the output of XNOR circuit 426 which receives the output of multiplexer circuit 422 and also receives the output of inverter circuit 428. Inverter circuit 428 receives the #p7 signal. Multiplexer 230c, at the other input receives the output of XNOR circuit 424 which receives the output of inverter circuit 428 and also receives the output of multiplexer circuit 420. Multiplexer circuit 422 receives at one input the #g6 signal and at the other input and output of NOR gate 418 which receives bits 6 of the A and B operand. Multiplexer 420 receives the same inputs as multiplexer 422. The select line of multiplexer 420 is controlled by the output of multiplexer 416. The select line of multiplexer 422 is controlled by the signal g05. The output of multiplexer 230d is bit 3 of the resultant sum and carried over bit 3 of 4-bit bus 242.

An important feature of the design of the adder of one embodiment of the present invention is to calculate multiple independent additions, and their associated carry-outs, with different word-lengths using only a single adder circuit. This is an important requirement for multi-media processors. The present invention provides partitioning without requiring the placement of a control gate on the carry chain for each partition because this would increase the delay the largest word size in proportion to the number of partitions. Another problem is that the carry out signal needs to be blocked at three places: 1) in the generation of the sum; 2) in the calculation of the remainder of the carries; and 3) in the generation of the group Cout.

The present invention provides a partitioning solution that does not produce any delay in the critical path 320 (FIG. 7A and FIG. 7B) and that produces all the three carries described above. In the following, a 16-bit adder is partitioned into four 4-bit adders, but this can be extended to any partition in multiple of four bits.

FIG. 6 illustrates the 16-bit adder 200 formed using the 4-bit groups 82-88 resulting in sums 240-246. The group generate and propagate signals are (g03, p03) for the first group and (g47, p47) for the second group, etc. In order to divide the adder circuit 200 into 4 adders of 4-bits each, then C3 needs to be made to zero for circuit block 512 which generates bits 4-7 of the sum; and C7 needs to be made to zero for circuit block 514 which generates bits 8-11 of the sum; and C11 needs to be made to zero for circuit block 516 which generates bits 12-15 of the sum. At the same time, these carries are still required for the generation of C15 (carry-out) and for other flag generation. However, if only C3 is made equal to zero, then incorrect values for C7, C11 and C15 will be generated due to their dependency on g01 and p23. The same applies to the other carry signals.

The present invention solves this problem by forcing p47 to zero (p8,11 and P12,15 for the other partitions). By making this propagate signal zero, all the carries dependent on this propagate signal will become zero and at the same time the carry-out generated by a block remains valid for the computation of any flag conditions. Since propagate signals do not lie on the critical timing path 320 (less loading than generate or carry signals), its control is readily performed and does not require any significant delay. Regarding the correct selection of the sum due to carry-in of “0,” the flag generation condition requires a delay of an XOR gate after the generation of the carry signal. Therefore, making the carry-in equal to zero for the sum selection does not cost any further delay, and at the same time reduces the load on the carry signal.

Table III below illustrates the partition control signal of line 212 (FIG. 6) and the partitioning result for the 64-bit adder implementation.

TABLE III

| Part1 | Part2 | Adder Operation |
|---|---|---|
| 0 | 0 | Byte |
| 0 | 1 | Half-Word (16-bit) |
| 1 | 0 | Word (32-bit) |
| 1 | 1 | Double Word (64-bit) |

The preferred embodiment of the present invention, a parallel carry lookahead adder having reduced transistor count and a fast critical timing carry path, is thus described. While the present invention has been described in particular embodiments, it should be appreciated that the present invention should not be construed as limited by such embodiments, but rather construed according to the below claims.

What is claimed is:

1. An n-bit adder circuit comprising:
a carry tree circuit for generating propagate and generate signals, said carry tree circuit comprising (logn) logic levels wherein a first logic level comprises (n/4) 4-bit generate and propagate (GP) circuits which each receive 4 bits of an n-bit operand A and also receive 4-bits of an n-bit operand B and wherein a first 4-bit GP circuit of said first logic level produces generate signal g03 and also produces propagate signal p03; and
a sum circuit coupled to respective n-bits of said A and B operands and for generating an n-bit sum based thereon, said sum circuit comprising: a 4-bit adder; and a plurality of 4-bit carry select adders that receive a portion of said generate signals, wherein said 4-bit adder generates bits 0-3 of said sum and wherein a first 4-bit carry select adder receives said g03 signal and generates bits 4-7 of said sum.

2. An n-bit adder circuit as described in claim 1 wherein a GP circuit of a second logic level of said carry tree circuit produces generate signal g07 and also produces propagate signal p07 and wherein a second 4-bit carry select adder of said sum circuit receives said g07 signal and generates bits 8-11 of said sum.

3. An n-bit adder circuit as described in claim 2 wherein a GP circuit of a third logic level of said carry tree circuit produces generate signal g0-11 and also produces propagate signal p0-11 and wherein a third 4-bit carry select adder of said sum circuit receives said g0-11 signal and generates bits 12-15 of said sum.

4. An n-bit adder circuit as described in claim 3 wherein a GP circuit of said third logic level produces generate g0-15 signal which is a carry-out for said n-bit adder circuit when n=16.

5. An n-bit adder circuit as described in claim 1 wherein each carry select adder of said sum circuit comprises:
a single integrated adder circuit that generates two addition sums based on two addition functions, a first sum based on a carry equal to “1” and a second sum based on a carry equal to “0;” and
a multiplexer circuit, controlled by a generate signal of said carry tree circuit, for selecting between said first and said second sum to produce 4 bits of said n-bit sum.

6. An n-bit adder circuit as described in claim 1 wherein the number of generate signals that are generated at a logic level, k, of said carry tree circuit is (n−2^{k}).

7. An n-bit adder circuit as described in claim 1 wherein the critical timing path is (logn+1) number of gates.

8. An n-bit adder circuit comprising:
a carry tree circuit for generating propagate and generate signals, said carry tree circuit comprising (logn) logic levels comprising:
a first logic level comprising (n/4) 4-bit generate and propagate (GP) circuits which each receive 4 bits of an operand A and 4-bits of an operand B and wherein a first 4-bit GP circuit produces generate signal g03 and propagate signal p03; and
a second logic level comprising GP circuits which receive output signals from said first logic level and which each comprise a multiplexer and a logic gate for high speed operation; and
a sum circuit coupled to respective n-bits of said A and B operands and for generating an n-bit sum based thereon, said sum circuit comprising (n/4) 4-bit carry select adders that receive a portion of said generate signals, wherein a first 4-bit carry select adder generates bits 0-3 of said sum and a second 4-bit carry select adder receives said g03 signal and generates bits 4-7 of said sum.

9. An n-bit adder as described in claim 8 wherein said logic gate within each of said GP circuits of said second logic level is a NOR gate.

10. An n-bit adder as described in claim 8 wherein said logic levels of said carry tree structure further comprise a third logic level comprising GP circuits which receive output signals from said second logic level and which each comprise a multiplexer and a logic gate.

11. An n-bit adder as described in claim 10 wherein said logic gate within each of said GP circuits of said third logic level is a NAND gate.

12. An n-bit adder circuit as described in claim 8 wherein a GP circuit of said second logic level of said carry tree circuit produces generate signal g07 and also produces propagate signal p07 and wherein a third 4-bit carry select adder of said sum circuit receives said g07 signal and generates bits 8-11 of said sum.

13. An n-bit adder circuit as described in claim 10 wherein a GP circuit of said second logic level of said carry tree circuit produces generate signal g07 and also produces propagate signal p07 and wherein a third 4-bit carry select adder of said sum circuit receives said g07 signal and generates bits 8-11 of said sum and wherein a GP circuit of said third logic level of said carry tree circuit produces generate signal g0-11 and also produces propagate signal p0-11 and wherein a fourth 4-bit carry select adder of said sum circuit receives said g0-11 signal and generates bits 12-15 of said sum.

14. An n-bit adder circuit as described in claim 13 wherein a GP circuit of said third logic level produces generate g0-15 signal which is a carry-out for said n-bit adder circuit when n=16.

15. An n-bit adder circuit as described in claim 8 wherein each carry select adder of said sum circuit comprises:
a single integrated adder circuit that generates two addition sums based on two addition functions, a first sum based on a carry equal to “1” and a second sum based on a carry equal to “0;” and
a multiplexer circuit, control by a generate signal of said carry tree circuit, for selecting between said first and said second sum to generate 4 bits of said n-bit sum.

16. An n-bit adder circuit comprising:
a carry tree circuit for generating propagate and group generate signals, said carry tree circuit comprising:
(logn) logic levels, wherein a first logic level of said carry tree circuit comprises (n/4) 4-bit generate and propagate (GP) circuits which each receive 4 bits of an operand A and 4 bits of an operand B and wherein a first 4-bit GP circuit produces generate signal g03 and propagate signal p03; and
first partitioning logic coupled to a portion of said propagate signals and responsive to a partition control signal, said first partitioning logic for partitioning said n-bit adder into smaller bit adders by controlling propagate signals between said logic levels;
a sum circuit coupled to respective n-bits of said A and B operands and for generating an n-bit sum based thereon, said sum circuit comprising (n/4) 4-bit carry select adders that receive a portion of said generate signals, wherein a first 4-bit carry select adder generates bits 0-3 of said sum and wherein a second 4-bit carry select adder receives said g03 signal and generates bits 4-7 of said sum.

17. An n-bit adder circuit as described in claim 16 further comprising second partition logic coupled between said carry tree circuit and said sum circuit, said second partition logic for partitioning said n-bit adder into said smaller bit adders by controlling a generate signal supplied to a carry select adder of said sum circuit.

18. An n-bit adder as described in claim 16 wherein said carry tree circuit further comprises a second logic level comprising GP circuits which receive output signals from said first logic level and which each comprise a multiplexer and a NOR gate for high speed operation.

19. An n-bit adder as described in claim 18 wherein said carry tree structure further comprises a third logic level comprising GP circuits which receive output signals from said second logic level and which each comprise a multiplexer and a NAND gate for high speed operation.

20. An n-bit adder circuit as described in claim 16 wherein a GP circuit of said second logic level produces generate signal g07 and also produces propagate signal p07 and wherein a third 4-bit carry select adder of said sum circuit receives said gO7 signal and generates bits 8-11 of said n-bit sum.

21. An n-bit adder circuit as described in claim 21 wherein a GP circuit of said third logic level produces generate signal g0-11 and also produces propagate signal p0-11 and wherein a fourth 4-bit carry select adder of said sum circuit receives said g0-11 signal and generates bits 12-15 of said n-bit sum.

22. An n-bit adder circuit as described in claim 21 wherein a GP circuit of said third logic level produces generate g0-15 signal which is a carry-out for said n-bit adder circuit when n=16.
